(19) United States
(12) Patent Application Publication
(10) Pub. No.: US 2007/0282688 A1
(43) Pub. Date: Dec. 6, 2007

(54) Personalized Method and Assembly for Advertising

(76) Inventors: Michael Ralph Buhrow, Elgin, IL (US); Ryan Russell Ruh, Elburn, IL (US)

Correspondence Address: VEDDER PRICE KAUFMAN & KAMMHOLZ, 222 N. LASALLE STREET, CHICAGO, IL, 60601, US

(21) Appl. No.: 11/757,065

(22) Filed: Jun. 1, 2007

Related U.S. Application Data
(60) Provisional application No. 60/803,678, filed on Jun. 1, 2006.

(51) Int. Cl. G06Q 30/00

(52) U.S. Cl. 705/14

(57) ABSTRACT

The following disclosure relates to a remote recording network using outdoor cameras having capacity for delayed broadcast used in tandem with pinpointed advertising to enhance advertisement efficacy. The disclosures also teaches of other useful improvements to enhance this overall method of advertising and associated assembly for personalized advertising such as the placement of several cameras at key locations such as a golf tee box or a golf green, the use of storage memory for the captured personalized sports camera by these cameras, the use of a plurality of different advertisements placed alongside a displayed performance, the use of a handheld phone equipped with a camera to record performances, the input by golfers to select the optimal sports segments to be displayed, and the use of a wireless or remote data communication system over a golf course.

### REFERENCE TO RELATED APPLICATION

The present patent application claims priority from and the benefit of U.S. Provisional Patent Application No. 60/803,678, filed Jun. 1, 2006, and entitled PERSONALIZED METHOD AND APPARATUS OF ADVERTISING, which prior application is hereby incorporated herein by reference.

### FIELD OF THE DISCLOSURE

The present disclosure relates generally to an improvement to marketing methods and apparatus, and more particularly, to a personalized method and assembly for advertising to an individual based on broadcasting an advertisement alongside a prerecorded sports performance of the person taken during a sports activity.

### BACKGROUND

Improved methods of advertisement are desirable in a market-based economy. Advertisers benefit from targeted or personalized media and communications that reach specific segments of the population. Since the needs and consuming habits of specific segments of the population are easy to ascertain and target, methods of advertising to a specific segment are more likely to increase efficiency of marketing and lead to enhanced sales.

Advertising in the modem world has reached a plateau where customers are often blase about passive advertisements. Once media saturation occurs, the placement of ads before a customer often has the opposite effect from that intended: a negative impression is made on potential customers instead of positive reinforcement. High-end segments of the marketplace are especially prone to saturation. In addition, this very difficult segment of the population shies away from advertisement and seeks activities away from the media, protected from the onslaught of advertising. Golfers are perhaps the acme of this situation, though the same might be said of any market segment to some extent.

Golfers frequently seek courses secluded from distraction, where the presence of advertising is minimized for the comfort of club members. In an effort by club owners to provide golfers with a marketing-free environment, carts are not cluttered with ads and goods sold in the clubhouse are modestly displayed on normal shelves. The same can also be said of a plurality of activities, sports, resorts, or hideaways where organizers or owners try to convey a sense of purity, remoteness, and harmony with nature.

Effective methods of advertisement that provide advantages to golfers, for which owners and organizers are willing to make exceptions to exclusive policies, are very valuable. When the advertisement is associated with a service, golfers may tolerate the advertisement to obtain the free service. Currently, only limited advertisements are shown to golfers on television screens in clubhouses. In exchange for a television broadcast of a sports event, golfers tolerate television ads. Clubhouse owners must then manage broadcast schedules, sound levels, and luminosity in an effort to accommodate the most hostile segment of the customers while providing an added external stimulus. For example, in a golf clubhouse, broadcasts of golf, fishing, or other events where outdoor scenes are shown might be preferable. One way to alleviate the problem of display broadcast management is to ask staff members to turn off the television between desired broadcasts. However, such monitoring can place an undesired burden on busy staff. Another way to solve this problem is to equip the clubhouse with a recording system where golfing events are stored, managed, and displayed to patrons in a closed-loop repetition. Once again, this method requires manpower and can be extremely vexing to habitual patrons who are exposed to the same broadcast repeatedly. The problem of sound associated with advertisement in this environment is also troublesome, as regular ads with sound tracks are often muted and they lose much of their efficacy. The advertising problem associated with this environment is unique and requires complex, inventive, and nonobvious solutions.

There exist many types of display-based advertisement, which include but are not limited to the display of a full-length ad within a regular broadcast, infomercials, tickers or crawls at the bottom, top, or side of a screen, print ads associated with the display, partial-frame or picture-in-picture ads placed alongside with broadcasts, etc. The goal of display-based ads is to capture the interest of a viewer using an appealing stimulus and gently transition the viewer's attention to an advertisement. For example, the use of a known golfing celebrity is known to promote sales in an ad. The prior art teaches improved methods of watching a tournament by placing a camera at the bottom of the cup of each hole in a certain manner. Other prior art teaches the use of different complicated monitoring technology designed to record rare and phenomenal acts such as holes-in-one on the golf course. The prior art does not address marketing concerns associated with the golfing environment. This art also fails to teach how to change or improve the secluded environment of a clubhouse.

What is desired is new method of advertising used in tandem with an assembly capable of enhancing the marketability of display ads within the clubhouse that integrates the harsh marketing realities of this sport.

### SUMMARY

What is desired is a new method of advertising and an associated assembly capable of being placed in the clubhouse, using the environment surrounding the clubhouse to provide a captive viewer with a stimulus sufficiently strong to create a very important and lasting interest in the advertisement. Players at the clubhouse share an interest in the game of golf. Patrons often make a brief stay at the clubhouse before playing, and upon completion of play, patrons may make a longer stay for drinks and/or food. Patrons often discuss their games and explain their best shots to other patrons, but they cannot show these shots to their friends. The display of a prerecorded golfing performance to the patron sitting at the clubhouse is a highly desirable service, one which creates a strong stimulus in the player to watch. This stimulus remains even if the desired performance is shown in loop. In addition, golf, like most sporting events with a moving element or ball, if filmed from specific locations, creates the movement of the elements on the display screen, which can be used to move the attention of patrons from the center of the screen onto advertisement placed at precise positions.

The following disclosure relates to a remote recording network using outdoor cameras having capacity for delayed broadcast used in tandem with pinpointed advertisement to enhance advertisement efficacy. The disclosures also teaches other useful improvements to enhance this overall method of advertising and associated assembly for personalized advertising such as the placement several cameras at key locations, such as a golf tee box or golf green, the use of storage memory for the captured personalized sports camera by these cameras, the use of a plurality of different advertisements placed in relation to a displayed performance, the use of a handheld phone equipped with a camera to record performances, the input of golf players to select the sports segments to be displayed, and the use of a wireless or remote data communication system over a golf course.

### BRIEF DESCRIPTION OF THE DRAWINGS

FIG. 1 is an aerial schematic view of the assembly for personalized advertising as implemented on a golf hole according to an embodiment of the present disclosure.

FIG. 2 is a schematic display of the main constituents of the assembly for personalized advertising of FIG. 1 according to an embodiment of the present disclosure.

FIG. 3 is a perspective schematic view of a recording post used within the assembly for personalized advertising according to an embodiment of the present disclosure.

FIG. 4 is a schematic diagram of a display used in the assembly for personalized advertising placed in the clubhouse illustrating a possible configuration of the different display elements shown in the display according to an embodiment of the present disclosure.

FIG. 5 is a functional cabling diagram of the recording and display elements of the assembly for personalized advertising of FIG. 1 having a plurality of cameras according to an embodiment of the present disclosure.

FIG. 6 is a schematic illustration of possible successive steps within the method and assembly for personalized advertising in accordance with an embodiment of the present disclosure.

FIG. 7 is a schematic illustration of possible successive steps within the method and assembly for advertising advertising in according with another embodiment of the present disclosure where a handheld wireless phone is used as a camera.

### DETAILED DESCRIPTION

For the purposes of promoting and understanding the principles disclosed herein, reference will now be made to the preferred embodiments illustrated in the drawings, and specific language will be used to describe the same. It is nevertheless understood that no limitation of the scope of the invention is intended. Such alterations and further modifications in the illustrated device and such further applications of the principles disclosed as illustrated herein are contemplated as would normally occur to one skilled in the art to which this disclosure relates.

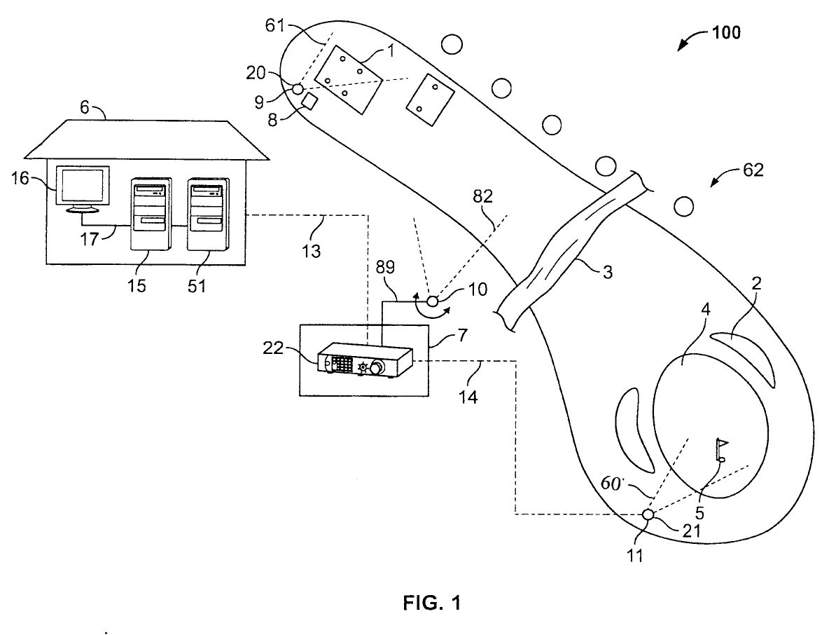

FIG. 1 is an aerial schematic view of the assembly for personalized advertising 100 as implemented on a golf hole 62 according to an embodiment of the present disclosure. A preferred embodiment relates to the method and associated assembly when applied to the practice of the sport of golf, a sport generally performed outdoors where video and photographic images can preferably be taken by placing a first camera 20 to capture the actions occurring on a golf tee box 1 and a second camera 21 to capture the actions occurring at the cup 5 on the golf green 4. It is understood by one of ordinary skill in the art that while the sport of golf is given as a preferred embodiment, this disclosure relates to any possible sports or leisure activity performed by a person that may be recorded for later broadcast and shown in a delayed playback to the same person while associated with advertising material. It is understood that the specific location, resolution, and number of cameras used to capture the sports performance is based on the dynamics and specifics of the sports activities as known in the art of broadcasting.

For the purpose of this disclosure, the term “sports” includes, in addition to traditional sporting activities, all physical activities that may be performed by a single individual or a team in the context of any leisure activity, in any type of environment, for the purpose of recreation or education. “Sports” includes, by way of nonlimiting examples, skiing, underwater hockey, polo, bowling, billiards, spelling bees, and chess tournaments.

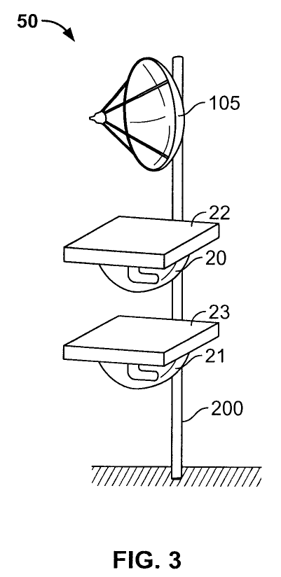

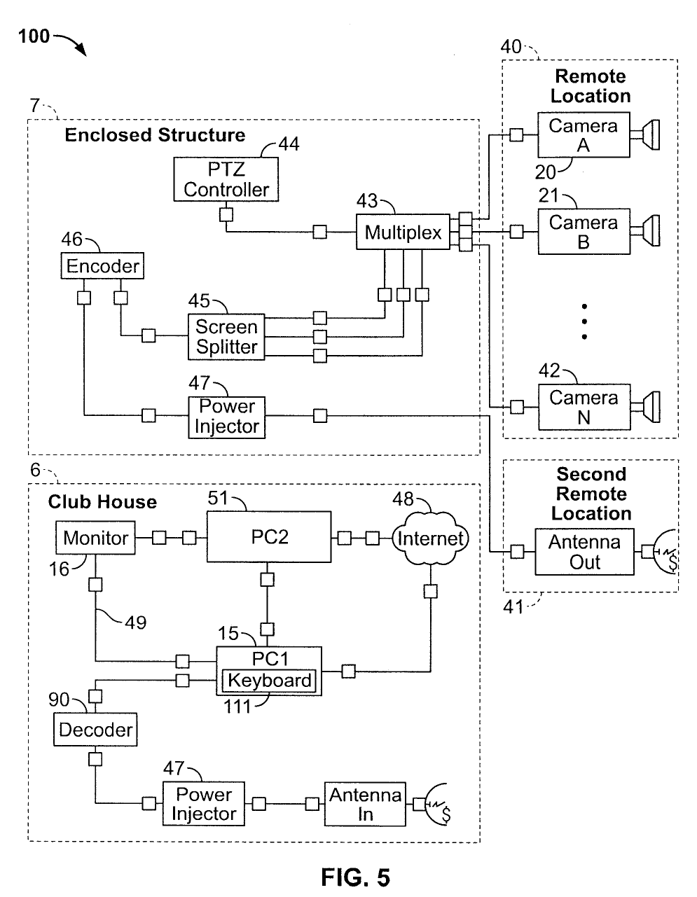

The assembly 100 shown in FIG. 1 as a first embodiment includes a first camera 20 and a second camera 21 placed on different posts 9, 10, 11 as shown in FIG. 1. FIG. 3 illustrates another embodiment where two cameras 20, 21 are placed in a vertical configuration on a single post 50. The configuration shown in FIG. 3 can be, for example, placed at the position shown as post 10 in the middle of the golf hole 62 capable of rotational movement as illustrated by a bidirectional arrow. FIG. 5 illustrates a possible configuration of the assembly 100 having a plurality of cameras ranging from A 20 to B 21 up to N 42, which can be placed as needed at a location where a sports activity may be recorded. The use of a series A, B, . . . N to number the cameras 20, 21, 42 is a mathematical tool to illustrate schematically a series of cameras that can range from the use of a single camera to a very large number of cameras. Returning to FIG. 1, the assembly 100 includes three cameras are placed along the golf hole 62, the first camera 20 is positioned 61 to capture the golf tee box 1, the second camera 21 is positioned 60 to capture the cup 5, and the third camera 82 is positioned to capture an intermediate position of the golf hole 62.1

FIG. 1 also shows other recognizable features associated with a golf hole 62, such as a sand trap 2, a green 4, a waterway 3, and a ball-cleaning station 8. A dashed line 14 illustrates a possible underground data communications connection between a remote performance signal processing unit 22 and post 11 where camera 21 is mounted. A continuous line is shown between post 10 and the performance signal processing unit 22 illustrating a possible above-ground connection 89, and no line is shown between post 9 and the performance signal processing unit 22 illustrating a possible wireless communication. One of ordinary skill in the art recognizes that what is shown and contemplated is the use of any known technology, associated with a single camera or a plurality of cameras, positioned either at a single location or a plurality locations operating in tandem with a performance signal processing unit 22 placed either in an enclosed structure 7 such as a pump house in one contemplated embodiment.

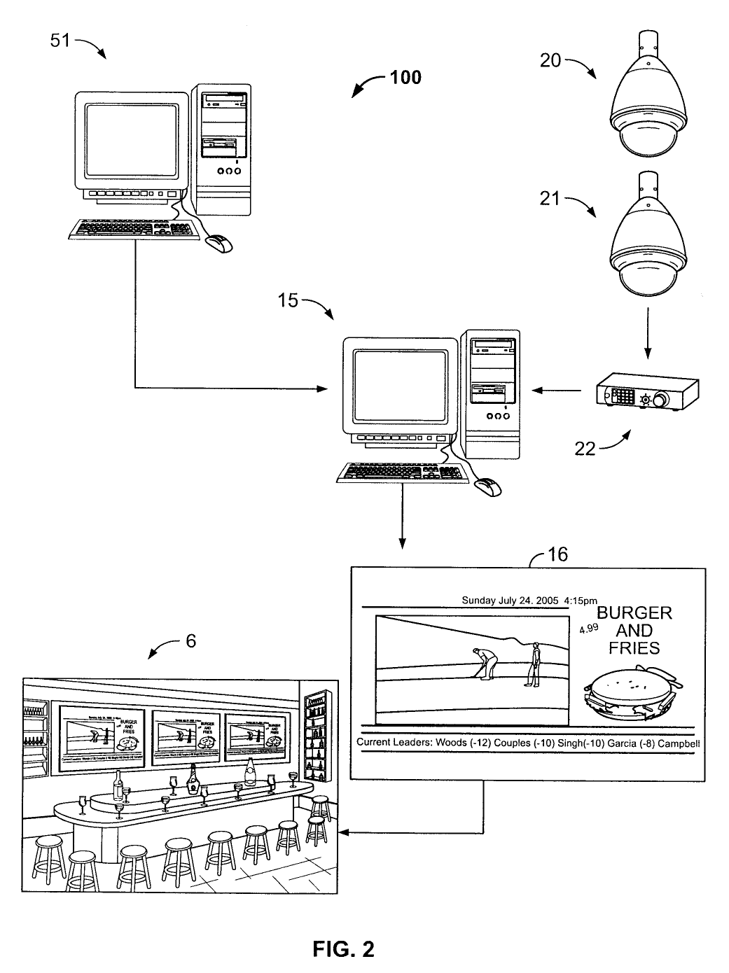

In a preferred embodiment of FIG. 3, the first and second cameras 20, 21 are external cameras equipped with a weather control dome attached in a pendant orientation. The first and second cameras 20, 21 are shown to be Panasonic HSNG PTZ CAMERA models, but any other suitable model is contemplated. FIG. 3 shows a configuration where the first and second cameras 20, 21 may be positioned under weather protection ledges 22, 23. In other embodiments shown in FIG. 2, the Panasonic HSNG PTZ cameras are already equipped with a weather protection shell. While external cameras with pendant-type fixations are shown, it is understood by one of ordinary skill in the art that any type of camera and fixation device may be used in association with this disclosure to record the sports performances either indoors or outdoors.

The signals from the first and second cameras 20, 21 are sent to the performance signal processing unit 22 where the signals are stored before preprocessing and sent to the performance signal delay unit 15. Delayed broadcasting may be obtained by a variety of means, including but not limited to the storage of the images in a memory such as a single memory, a plurality of memories, shared memory, a compact disc (CD), a digital video disc (DVD), a read-only memory, a random access memory, an electrically erasable programmable read-only memory, optical storage memory, and other nonvolatile storage media capable of storing digital data for use by a processor, a buffer, or a portable memory unit. What is also contemplated is the use of an external device such as TIVO™ or DirectTV™, the internal storage of new generation of display devices equipped with inner storage devices, or delayed data transfer in association with either network or streaming technology.

FIG. 1 illustrates a system control and monitoring device 51 connected for data communication 17 to the display management device 16. In one embodiment, both the system control and monitoring device 51 and the performance signal delay unit 15 are personal computers equipped with a keyboard, a mouse, a computer processing unit (CPU), and a monitor as shown in FIG. 2. What is shown is a first-generation device where known interfaces may be redundant, but what is also contemplated is the use of optimized devices, where user interfaces have been merged and simplified into a single piece of equipment with a single user interface and a memory.

The recording device as shown in FIG. 5 shows a schematic layout of the varied electronic elements of the assembly for broadcasting a sports performance according to FIG. 2 with two cameras 20, 21 according to a first embodiment. FIG. 1 shows a different camera configuration where three cameras 20, 21, 82 are shown. It is understood by one of ordinary skill in the art that the selection of a specific golf hole, which in a preferred embodiment is hole 62, is only indicative of a proper location from among numerous possible locations where the cameras 20, 21, 82 and the mounting posts 9, 10, 11 can be located. In the specific embodiment of golf, players generally reach the clubhouse 6 after completing either 9 or 18 holes of golf. The choice of the hole may be based on considerations such as, but not limited to, the determination of when the delayed sports performance is of interest to persons located in the clubhouse 6. In yet another embodiment, the selection of the personalized sports performance is made by activating a selector (not shown) or by an automatic selection by the advertising target at a clubhouse. The selector in an embodiment is a cell phone pad, and in another embodiment the selector is an operator located at the club house 6 entering manually the choice using the system control and monitoring device.

One possible embodiment as shown as FIG. 5 is a functional diagram of the recording and display elements of the assembly 100 for personalized advertisement of FIG. 1 with a plurality of cameras 21, 21, 42. In the diagram, four functional zones are shown, namely, the enclosed structure 7, the club house 6, the first remote location 40, and the second remote location 41. It is understood by one of ordinary skill in the art that the functional cabling diagram shown in FIG. 5 can be configured for cabling as shown in FIG. 1 with three cameras, where an antenna out 105 as shown in FIG. 3 is located above the cameras 20, 21 and is functionally connected with an antenna located at the club house 6. While each zone is functionally connected in FIG. 5 by either direct connections or wireless connections via an antenna, one of ordinary skill in the art recognizes once again that different configurations of the proposed network are contemplated. Each element as shown is connected to other elements by a line and small boxes. In the selected diagram, the lines correspond to any method of data communication including cables, lines, wireless communications, and manual data transfer, and the small boxes illustrate connectors for attaching the different cables, lines, and wireless communication devices. One of ordinary skill in the art recognizes that these boxes are provided for convenience and illustrative purposes and do not correspond to mandatory elements that cannot be removed by directly merging multiple elements into single elements. What is also contemplated is the design and installation of functional boxes containing and regrouping a plurality of these elements for convenience purposes. In the simplest configuration, the monitor 16 includes an internal structure sufficient to allow for direct communication with the different cameras.

In FIG. 5, each camera A, B, . . . N (20, 21, . . . 42) is capable of capturing a different personalized sports performance and directing the captured data via a connection to the multiplexer 43 of the enclosed structure 7, which is able to receive the captured personalized sports performances for the different cameras used in the configuration. A screen splitter 45 is then used to combine the different captured personalized sports performances into a single feed before the combined feed is sent to encoder 46. While a configuration is shown where the different signals are split by the multiplexer 43 into a split screen by the screen splitter 45 for encoding, what is contemplated is the use of any type of camera feed digitalization that results in the transfer of captured personalized sports performances to the performance signal display unit 15 shown in FIG. 5 as the PC1 with keyboard.

The encoded signal is then injected with power by a power injector 47 before it is sent out to the second remote location 41, where it is then emitted by an antenna. While an antenna-based system is shown, what is contemplated is the use of any system capable of sending the encoded signal to the club house 6. On the other end of the antenna out, an antenna in is equipped to receive the signal. The captured personalized sports performances are then modulated in power, either increased in power if the signal received is too weak, or lowered in power if the signal is too powerful, to be injected back into the system via the power injector 47. What is shown as two different power injectors 47 located at both ends of the antenna is a single system of power regulation designed to operate in tandem with the antenna. A decoder 90 is used to decode the signal previously encoded by the encoder 46 at the enclosed structure 7. While one protocol of communication associated with a single encoding/decoding step is shown, what is contemplated is the use of any type of signal encoding and decoding, such as but not limited to certificate coding and modulation coding, which allows the system to protect the information from external interferences or tampering.

The decoder 90 is then connected to the performance signal relay unit 15, which is also connected to the system control and monitoring device 51. The performance signal relay unit 15 is also connected, as for the system control and monitoring device 51 to an Internet 48 or other network such as a Local Area Network (LAN) (not shown) or in communication with the display monitor 16. In one preferred embodiment, the performance signal relay unit 15 and the system control and monitoring device 51 are personal computers. The preferred embodiment contemplates the use of two different portable computers to obtain and manage the image data 15, 51 and to manage and produce advertising materials to be placed alongside the sports performance of an advertising target. FIGS. 1 and 2 show possible embodiments of use of these two personal computers.

FIG. 5 shows one possible graphical display of the display device 16. As shown in FIG. 1, the display device 16 may be installed at a fixed location where a person previously engaged in a sports performance is likely to be disposed to view advertising when associated with a delayed display of his or her own sports performance. In a preferred embodiment, a wide-screen plasma television is used as a display device 16. While one possible embodiment is disclosed, it is understood that any type of display technology is contemplated for the display device 16, including front projectors, rear projectors, computer monitors, televisions, and the like. FIG. 2 illustrates schematically how the signal of the first camera 20 and the second camera 21 are processed by the performance signal processing unit 22 and delivered to the performance signal delay unit 15 where the performance can be delayed before display on a display 16 placed in a location 6 such as the clubhouse. The system control and monitoring device 51 is used to monitor and control the streaming of information, regulate ad content, and offer programming tools in order to regulate the entire assembly 100.

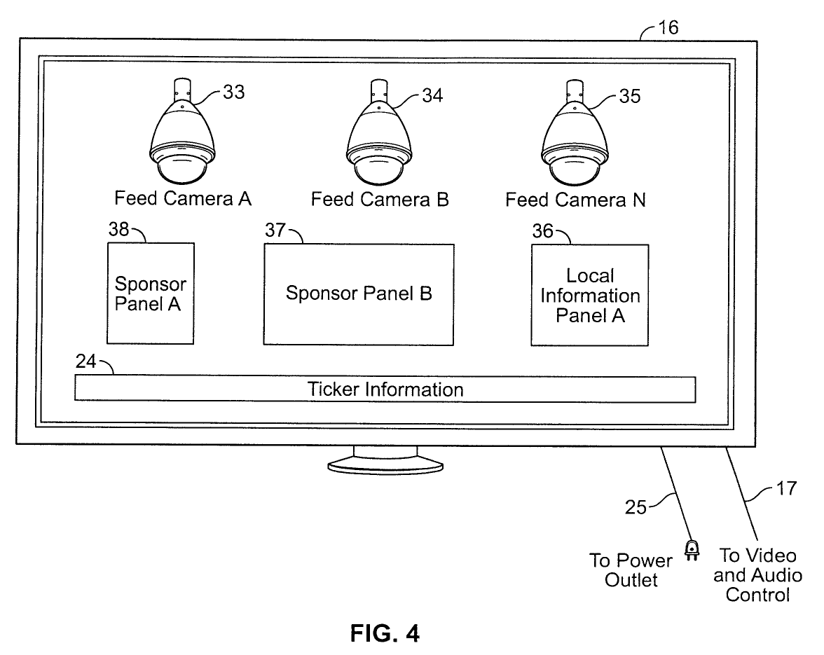

A close-up view of the display device 16 in one possible embodiment is shown in FIG. 4. The display device 16 with a display surface can be split by the assembly into several sections of information, including but not limited to advertising and the display of personalized sports performances of an advertisement target, such as a golfer. Once again, these sections are only illustrative on one possible configuration that can be selected by the assembly operator using the system control and monitoring device 51. These sections include but are not limited to a first camera feed 33 (shown as camera A), a second camera feed 34 (shown as camera B), and a third camera feed 35 (shown as camera N). It is understood that while three different camera feeds are shown, these three personalized sports performances can correspond to different camera angles of the same golf hole 62, of different sports performances of different advertising targets (e.g., the last three golfers), or even different sports performances of the same advertisement target at three consecutive or selected holes. In a nonlimiting example, the feed camera A consists of the sports performance from a first person on the putting green, the feed camera B is the sports performance from the same person at the tee box of same golf hole, and the feed camera C is a second person at the putting green. The present disclosure contemplates use of either a plurality of cameras in association with delayed sports performances or a single camera.

FIG. 4 also shows a display 16 where several types of advertisements in different panels 38, 37, 36, 24 or positions can be displayed alongside the different camera feeds 33, 34, 35. The advertisement may include in one possible embodiment a sponsor panel A 38 to promote a first sponsor, a panel B 37 to promote a second sponsor, and a local information panel 36. The display is also equipped with a ticker zone 24, news crawl, or scrolling marquise arranged at the bottom of the advertisement. FIG. 1 shows the display 16 according to another embodiment where a first sponsor panel is situated at the right of only one camera feed and a ticker is placed at the bottom of the display device. While two possible embodiments are shown, it is understood by one of ordinary skill that a plurality of camera feeds and sponsor information may be arranged on the display 16 according to any desired configuration. In addition, while only camera feeds 33, 34, 35 are shown in FIG. 4, what is also contemplated is the use of other types of information feeds that may be displayed, including but not limited to the local weather, sports information, tournament scoring, etc. The display 16 is also equipped with a power outlet 25 and a video and audio control 17 shown in FIG. 4 as cables.

FIG. 1 shows an assembly for personalized advertising 100 where the assembly includes a stand 50 shown in FIG. 3 with a first camera 20 to captures a performance signal 33, a performance signal processing unit 22 in data communication with the first camera 20, a performance signal delay unit 15 in data communication with the performance signal processing unit 22 for delaying the performance signal 33 as shown in FIG. 4, and an advertisement signal processor such as the processor of the system control and monitoring device 51 for producing an advertisement signal such as sponsor panel A 38, sponsor panel B 37, local information panel A 36, or even an information ticker 24.

The assembly 100 also includes a display device 16 connected to the performance delay unit 22 having a processor for displaying the delayed performance signal and the advertisement signal generally concurrently. The performance signal processing unit 22, shown enclosed in the structure 7 in FIG. 5, includes the multiplexer 43, the PTZ controller 44, the signal splitter 45, and the encoder 46. In yet another embodiment, the performance signal delay unit 15 designed to delay the performance signal includes a decoder 90, a first computing device for management of the display, and a second computing device to control the delay of the performance signal.

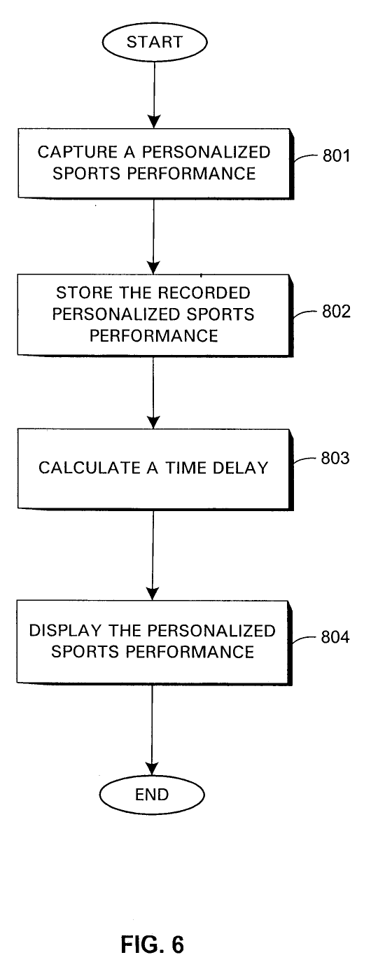

FIG. 6 is a schematic illustration of possible successive steps within the method and assembly for personalized advertising in accordance with an embodiment of the present disclosure. The method comprises a series of successive steps, in consecutive or nonconsecutive order. The steps include the capture 801 of a personalized sports performance of an advertising target with a camera assembly 100, the storage 802 of the recorded personalized sports performance of the advertising target in a memory, the calculation 803 of a time delay after recording the personalized sports performance to coordinate with the arrival of the advertising target in front of the display 16 where an advertisement is shown, and the display 804 of the personalized sports performance on the display 16 after the time delay along with the advertisement. What is also contemplated is the use of a personalized sports performance made of a successive association of a first segment and a second segment taken successively.

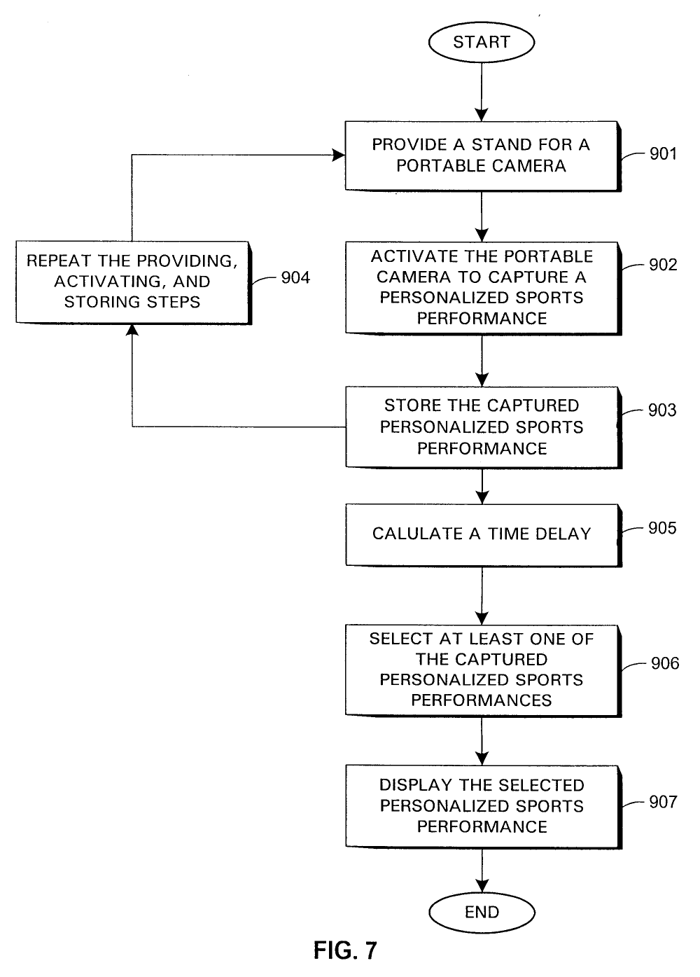

FIG. 7 is a schematic illustration of possible successive steps within the method and assembly for personalized advertising in according with another embodiment of the present disclosure where a handheld wireless phone is used as a camera. The method includes the steps of providing 901 a stand for a portable camera, activating 902 the portable camera to capture a personalized sports performance of an advertising target, storing 903 the captured personalized sports performance of the advertising target in a memory, repeating 904 the providing, activating and storing steps a predetermined number of occurrences, each at different locations, calculating 905 a time delay after storing the captured personalized sports performance of a last of the predetermined number of occurrences to coordinate with the arrival of the advertising target in front of a display where an advertisement can be shown, selecting 906 at least one of the captured personalized sports performances, and displaying 907 the selected at least one of the captured personalized sport performances on the display after the calculated time delay with the advertisement. In one contemplated embodiment, the portable camera is selected from the group consisting of a wireless phone, a portable digital assistant, a digital camera, and a handheld video camera.

Persons of ordinary skill in the art appreciate that although the teachings of the disclosure have been illustrated in connection with certain embodiments, there is no intent to limit the invention to such embodiments. On the contrary, the intention of this disclosure is to cover all modifications and embodiments failing fairly within the scope of the teachings of the disclosure.

What is claimed is:

1. A method of personalized advertising, comprising the steps of:
capturing a personalized sports performance of an advertising target with a camera assembly;
storing the recorded personalized sports performance of the advertising target in a memory;
calculating a time delay after recording the personalized sports performance to coordinate with an arrival of the advertising target in front of a display where an advertisement can be shown; and
displaying the personalized sports performance on the display after the time delay along with the advertisement.

2. The method of personalized advertising of claim 1, wherein the camera assembly comprises a first camera for capturing a first segment of the personalized sports performance, and a second camera for capturing a second segment of the personalized sports performance, wherein the personalized sports performance is a successive association of the first segment and the second segment.

3. The method of personalized advertisement of claim 2, wherein the step of capturing the personalized sports performance occurs in the context of a golf play, on a golf course, and the advertising target is a golfer.

4. The method of personalized advertisement of claim 1, wherein the memory is taken from the group consisting of a single memory, a plurality of memories, a shared memory, a compact disc, a digital video disc, a read-only memory, a random access memory, an electrically erasable programmable read-only memory, optical storage memory, and other nonvolatile storage media capable of storing digital data for retrieval and use by a processor.

5. The method of personalized advertisement of claim 4, wherein the advertisement is a visual advertisement disposed adjacent to the personalized sports performance on the display.

6. A method of personalized advertising, comprising the steps of:
providing a stand for a portable camera;
activating the portable camera to capture a personalized sports performance of an advertising target;
storing the captured personalized sports performance of the advertising target in a memory;
repeating the providing, activating, and storing steps a predetermined number of occurrences, each at different locations;
calculating a time delay after storing the captured personalized sports performance of a last of the predetermined number of occurrences to coordinate with an arrival of the advertising target in front of a display where an advertisement can be shown;
selecting at least one of the captured personalized sports performances; and
displaying the selected at least one of the captured personalized sport performances on the display after the calculated time delay with the advertisement.

7. The method of personalized advertising of claim 6, wherein the portable camera is selected from the group consisting of a wireless phone, a portable digital assistant, a digital camera, and a handheld video camera.

8. The method of personalized advertising of claim 6, wherein the selection of the personalized sports performance is made by activating a selector or by an automatic selection by the advertising target at a clubhouse.

9. The method of personalized advertising of claim 6, wherein the different locations comprise at least a location adjacent to a tee box and adjacent to a green.

10. The method of personalized advertisement of claim 6, wherein the memory taken from the group consisting of a single memory, a plurality of memories, a shared memory, a compact disc, a digital video disc, a read-only memory, a random access memory, an electrically erasable programmable read-only memory, an optical storage memory, and other nonvolatile storage capable of storing digital data for use by a processor.

11. An assembly for personalized advertising, the assembly comprising:
a stand including a first camera that captures a performance signal;
a performance signal processing unit in data communication with the first camera;
a performance signal delay unit in data communication with the performance signal processing unit for delaying the performance signal, and including an advertisement signal processor for producing an advertisement signal; and
a display device connected to the performance delay unit processor for displaying the delayed performance signal and the advertisement signal generally concurrently.

12. The assembly for personalized advertising of claim 11, wherein the performance signal processing unit comprises a multiplexer, a controller, a signal splitter, and an encoder.

13. The assembly for personalized advertising of claim 11, wherein the performance signal processing unit is in data communication with the camera via a wireless communication.

14. The assembly for personalized advertising of claim 11, wherein the performance signal delay unit is in data communication with the performance signal processing unit via a wireless communication.

15. The assembly for personalized advertising of claim 11, further comprising a second camera in data communication with the performance signal processing unit.

16. The assembly for personalized advertising of claim 12, wherein the performance signal delay unit comprises a decoder and a first computing device for management of the display and a second computing device to control the delay of the performance signal.

17. The assembly for personalized advertising of claim 11, wherein the performance signal delay unit is in connected to the Internet or a local area network.
